(19) United States
(12) Patent Application Publication
(10) Pub. No.: US 2011/0282981 A1
(43) Pub. Date: Nov. 17, 2011

(54) BEHAVIORAL RULE RESULTS

(75) Inventors: Kevin Scott Cutler, Carp (CA); Kalyan Premchand Siddam, Nepean (CA)

(73) Assignee: Alcatel-Lucent Canada Inc., Ottawa (CA)

(21) Appl. No.: 12/777,713

(22) Filed: May 11, 2010

(51) Int. Cl. G06F 15/173; H04L 12/28

(52) U.S. Cl. 709/223; 709/225; 370/254

(57) ABSTRACT

Various exemplary embodiments relate to a method and related network node including one or more of the following: receiving a message at a PCRN; determining whether a policy decision should be made with regard to the received message; when a policy decision should be made: identifying a rule of a plurality of rules as applicable to processing the received message, wherein the identified rule specifies an action to be taken in response to the received message, performing the action in response to the received message; and when a policy decision should not be made, processing the received message according to normal procedures. Such action may include one or more of the following: rejecting a request, accepting a request, modifying a request, and performing a predefined routine.

### TECHNICAL FIELD

Various exemplary embodiments disclosed herein relate generally to policy and charging in telecommunications networks.

### BACKGROUND

As demand increases for varying types of applications within mobile telecommunications networks, service providers constantly upgrade their systems in order to reliably provide an expanded functionality. What was once a system designed simply for voice communication has grown into an all-purpose network access point, providing access to a myriad of applications including text messaging, multimedia streaming, and general Internet access. In order to support such applications, providers have built new networks on top of their existing voice networks. As seen in second and third generation networks, voice services must be carried over dedicated voice channels and directed toward a circuit-switched core, while other service communications are transmitted according to the internet protocol (IP) and directed toward a different, packet-switched core. This led to unique problems regarding application provision, metering and charging, and quality of experience (QoE) assurance.

In an effort to simplify the dual core approach of the second and third generations, the 3rd Generation Partnership Project (3GPP) has recommended a new network scheme it terms “long term evolution” (LTE). In an LTE network, all communications are carried over an IP channel from user equipment (UE) to an all-IP core called the evolved packet core (EPC). The EPC then provides gateway access to other networks while ensuring an acceptable QoE and charging a subscriber for their particular network activity.

The 3GPP generally describes the components of the EPC and their interactions with each other in a number of technical specifications. Specifically, 3GPP TS 29.212, 3GPP TS 29.213, and 3GPP TS 29.214 describe the policy and charging rules function (PCRF), policy and charging enforcement function (PCEF), and bearer binding and event reporting function (BBERF) of the EPC. These specifications further provide some guidance as to how these elements interact in order to provide reliable data services and charge subscribers for use thereof.

For example, 3GPP TS 29.212 and 3GPP TS 29.214 provide some guidance on the establishment of an application session by the EPC upon receipt of an application request from an application function (AF) in the form of an aa-request (AAR) message or from a packet data network gateway (PGW) in the form of a credit control request (CCR) message. The standards specify that the PCRF is responsible for receiving requests, establishing IP-CAN and gateway control sessions, creating new policy and charging control (PCC) rules commensurate with such requests, and providing these new PCC rules to the PCEF for installation. The 3GPP standards also define the format of various messages and PCC rules.

The 3GPP standards do not, however, describe how the PCRF should interpret a request, establish sessions, or create PCC rules. Such functionality is desired for the operation of the EPC. Without an infrastructure to establish various sessions or create appropriate PCC rules based on a request, the EPC may not be able to provide service to user equipment, charge subscribers for application usage, or ensure that a certain QoE level is met in providing services. Indeed, the 3GPP standards fall short of describing how the PCRF should process and respond to the various possible messages that may be sent by an SGW, PGW, or AF.

In view of the foregoing, it would be desirable to provide a flexible method of processing messages received at a PCRF. In particular, it would be desirable to provide a customizable process by which a PCRF may receive a message from another node and take appropriate action in response.

### SUMMARY

In light of the present need for a flexible method of processing messages received at a policy and charging rules node (PCRN), a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method, related network node, and related machine-readable storage medium including one or more of the following: receiving a message at a PCRN; determining whether a policy decision should be made with regard to the received message; when a policy decision should be made: identifying a rule of a plurality of rules as applicable to processing the received message, wherein the identified rule specifies an action to be taken in response to the received message, performing the action in response to the received message; and when a policy decision should not be made, processing the received message according to normal procedures. Such action may include one or more of the following: rejecting a request, accepting a request, modifying a request, and performing a predefined routine.

Various alternative embodiments relate to a policy and charging rules node including one or more of the following: an interface that receives a message from another node; a rule storage that stores a plurality of rules, wherein at least one rule includes an indication of an action to be taken in response to the received message; a message handler configured to: determine that a policy decision should be made with regard to the message, and request a policy decision; and a policy decision engine that: determine that the at least one rule of the plurality of rules is applicable to a current context, and return the indication of the action to the message handler, wherein the message handler subsequently performs the action.

According to the foregoing, various exemplary embodiments provide for the externalization of PCRN behavior. Particularly, by providing behavioral rules for determining what action a PCRN should take in response to a received message, a manufacturer or a user may define how a PCRN responds to a message under various circumstances. Thus, the behavior of a PCRN may be fine-tuned to handle differing situations in appropriate manners and may be updated to evolve with the network.

### BRIEF DESCRIPTION OF THE DRAWINGS

In order to better understand various exemplary embodiments, reference is made to the accompanying drawings, wherein:

FIG. 1 illustrates an exemplary subscriber network for providing various data services;

FIG. 2 illustrates an exemplary policy and charging rules node (PCRN) for providing externalized behavior;

FIG. 3 illustrates an exemplary data arrangement for storing policy decision rules in the embodiment shown in FIG. 2;

FIG. 4 illustrates an exemplary data arrangement for storing predefined routines in the embodiment shown in FIG. 2;

FIG. 5 illustrates an exemplary method for processing a received message in accordance with an action indicated by a policy decision result in the embodiment shown in FIG. 2; and

FIG. 6 illustrates and exemplary method for performing a policy decision in the embodiment shown in FIG. 2.

### DETAILED DESCRIPTION

Referring now to the drawings, in which like numerals refer to like components or steps, there are disclosed broad aspects of various exemplary embodiments.

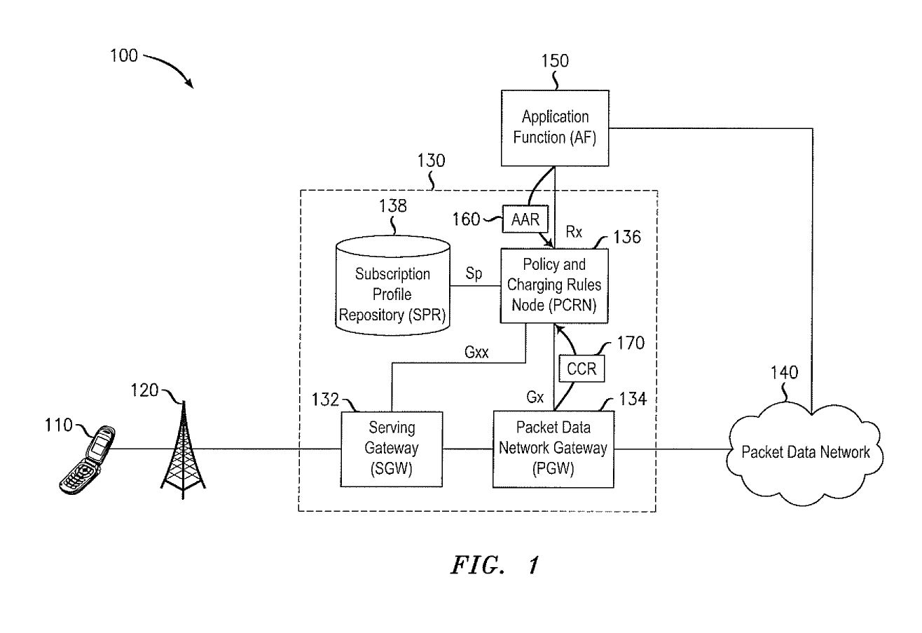

FIG. 1 illustrates an exemplary subscriber network 100 for providing various data services. Exemplary subscriber network 100 may be a communications network, such as an LTE or 4G mobile communications network, for providing access to various services. The network 100 may include user equipment 110, base station 120, evolved packet core (EPC) 130, packet data network 140, and application function (AF) 150.

User equipment 110 may be a device that communicates with packet data network 140 for providing an end-user with a data service. Such data service may include, for example, voice communication, text messaging, multimedia streaming, and Internet access. More specifically, in various exemplary embodiments, user equipment 110 is a personal or laptop computer, wireless email device, cell phone, television set-top box, or any other device capable of communicating with other devices via EPC 130.

Base station 120 may be a device that enables communication between user equipment 110 and EPC 130. For example, base station 120 may be a base transceiver station such as an evolved nodeB (eNodeB) as defined by 3GPP standards. Thus, base station 120 may be a device that communicates with user equipment 110 via a first medium, such as radio waves, and communicates with EPC 130 via a second medium, such as Ethernet cable. Base station 120 may be in direct communication with EPC 130 or may communicate via a number of intermediate nodes (not shown). In various embodiments, multiple base stations (not shown) may be present to provide mobility to user equipment 110. Note that in various alternative embodiments, user equipment 110 may communicate directly with EPC 130. In such embodiments, base station 120 may not be present.

Evolved packet core (EPC) 130 may be a device or association of devices that provides user equipment 110 with gateway access to packet data network 140. EPC 130 may further charge a subscriber for use of provided data services and ensure that particular quality of experience (QoE) standards are met. Thus, EPC 130 may be implemented, at least in part, according to the 3GPP TS 29.212, 29.213, and 29.214 standards. Accordingly, EPC 130 may include a serving gateway (SGW) 132, a packet data network gateway (PGW) 134, a policy and charging rules node (PCRN) 136, and a subscription profile repository (SPR) 138.

Serving gateway (SGW) 132 may be a device that provides gateway access to the EPC 130 to an end user of network 100. SGW 132 may be the first device within the EPC 130 that receives packets sent by user equipment 110. SGW 132 may forward such packets toward PGW 134. SGW 132 may perform a number of functions such as, for example, managing mobility of user equipment 110 between multiple base stations (not shown) and enforcing particular quality of service (QoS) characteristics for each flow being served. In various implementations, such as those implementing the proxy mobile IP (PMIP) standard, SGW 132 may include a bearer binding and event reporting function (BBERF). In various exemplary embodiments, EPC 130 may include multiple SGWs (not shown) and each SGW may communicate with multiple base stations (not shown).

Packet data network gateway (PGW) 134 may be a device that provides gateway access to packet data network 140 to an end user of network 100. PGW 134 may be the final device within the EPC 130 that receives packets sent by user equipment 110 toward packet data network 140 via SGW 132. PGW 134 may include a policy and charging enforcement function (PCEF) that enforces policy and charging control (PCC) rules for each service data flow (SDF). Therefore, PGW 134 may be a policy and charging enforcement node (PCEN). PGW 134 may include a number of additional features such as, for example, packet filtering, deep packet inspection, and subscriber charging support. PGW 134 may also be responsible for requesting resource allocation for unknown application services. Upon receiving a request for an unknown application service from UE 110, PGW may construct a credit control request (CCR), such as, for example, CCR 170, requesting an appropriate allocation of resources and forward the request to PCRN 136.

It should be noted that while exemplary network 100 corresponds to one particular implementation of long term evolution (LTE), many variations may exist. For example, SGW 132 may not be present, PGW 134 may not be present, and/or the functions of SGW 132 and PGW 134 may be consolidated into a single device or spread across multiple additional devices.

Policy and charging rules node (PCRN) 136 may be a device that receives requests related to service data flows (SDFs) and IP-CAN sessions, generates PCC rules, and provides PCC rules to the PGW 134 and/or other PCENs (not shown). PCRN 136 may be in communication with AF 150 via an Rx interface. PCRN 136 may receive an application request in the form of an aa-request (AAR) 160 from AF 150. Upon receipt of AAR 160, PCRN 136 may generate at least one new PCC rule for fulfilling the application request 160.

PCRN 136 may also be in communication with SGW 132 and PGW 134 via a Gxx and a Gx interface, respectively. PCRN 136 may receive a request in the form of a credit control request (CCR) 170 from SGW 132 or PGW 134. As with AAR 160, upon receipt of CCR 170, PCRN may take appropriate action in response, such as, for example, generating at least one new PCC rule for fulfilling and/or responding to the CCR 170. In various embodiments, AAR 160 and CCR 170 may represent two independent requests to be processed separately, while in other embodiments, AAR 160 and CCR 170 may carry information regarding a single request, and PCRN 136 may take action based on the combination of AAR 160 and CCR 170. In various embodiments, PCRN 136 may be capable of handling both single-message and paired-message requests.

Upon creating a new PCC rule or upon request by the PGW 134, PCRN 136 may provide a PCC rule to PGW 134 via the Gx interface. In various embodiments, such as those implementing the PMIP standard for example, PCRN 136 may also generate quality of service (QoS) rules. Upon creating a new QoS rule or upon request by the SGW 132, PCRN 136 may provide a QoS rule to SGW 132 via the Gxx interface.

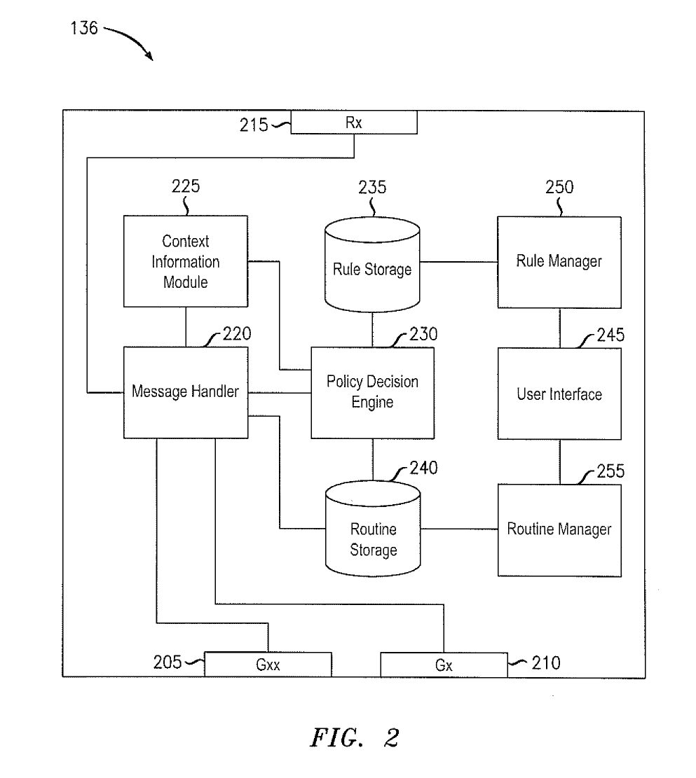

In processing various requests and other messages, PCRN 136 may make use of one or more behavioral rules, the details of which will be described below with reference to FIGS. 2-6. PCRN 136 may locate an applicable behavioral rule for a particular request, conflict, or event, and take at least one action specified by the applicable behavioral rule. In various embodiments, such a behavioral rule may include a reference to a predefined routine that the PCRN 136 may perform in response to a request or other message.

Subscription profile repository (SPR) 138 may be a device that stores information related to subscribers to the subscriber network 100. Thus, SPR 138 may include a machine-readable storage medium such as read-only memory (ROM), random-access memory (RAM), magnetic disk storage media, optical storage media, flash-memory devices, and/or similar storage media. SPR 138 may be a component of PCRN 136 or may constitute an independent node within EPC 130. Data stored by SPR 138 may include an identifier of each subscriber and indications of subscription information for each subscriber such as, for example, subscriber category, bandwidth limits, charging parameters, and subscriber priority.

Packet data network 140 may be a network (e.g., the Internet or another network of communications devices) for providing data communications between user equipment 110 and other devices connected to packet data network 140, such as AF 150. Packet data network 140 may further provide, for example, phone and/or Internet service to various user devices in communication with packet data network 140.

Application function (AF) 150 may be a device that provides a known application service to user equipment 110. Thus, AF 150 may be a server or other device that provides, for example, a video streaming or voice communication service to user equipment 110. AF 150 may further be in communication with the PCRN 136 of the EPC 130 via an Rx interface. When AF 150 is to begin providing known application service to user equipment 110, AF 150 may generate an application request message, such as an aa-request (AAR) 160 defined by the Diameter protocol, to notify the PCRN 136 that resources should be allocated for the application service. This application request message may include information such as an identification of a subscriber using the application service and an identification of the particular service data flows desired to be established in order to provide the requested service. AF 150 may communicate such an application request to the PCRN 136 via the Rx interface.

Having described the components of subscriber network 100, a brief summary of the operation of subscriber network 100 will be provided. It should be apparent that the following description is intended to provide an overview of the operation of subscriber network 100 and is therefore a simplification in some respects. The detailed operation of subscriber network 100 will be described in further detail below in connection with FIGS. 2-6.

PCRN 136 may receive a request for establishment of a service data flow (SDF) such as, for example, AAR 160 and/or CCR 170. In attempting to establish the requested SDF, PCRN 136 may determine that there is a conflict between the request and a subscriber profile. For example, the request may specify that 512 kbps of bandwidth is requested while a subscriber record may indicate that the subscriber is only allowed to have 256 kbps of bandwidth. To resolve this conflict, PCRN 136 may locate an applicable behavioral rule that indicates that the request should be rejected. Subsequently, PCRN 136 may reject the request in accordance with the applicable rule.

FIG. 2 illustrates an exemplary policy and charging rules node (PCRN) for providing externalized behavior. PCRN 136 may include a Gxx interface 205, a Gx interface 210, an Rx interface 215, a message handler 220, a context information module 225, a policy decision engine 230, a rule storage 235, a routine storage 240, a user interface 245, a rule manager 250, and a routine manager 255.

Gxx interface 205 may be an interface comprising hardware and/or executable instructions encoded on a machine-readable storage medium configured to communicate with a SGW such as SGW 132. Such communication may be implemented according to the 3GPP TS 29.212. Thus, Gxx interface 205 may receive requests for QoS rules and transmit QoS rules for installation. Gxx interface 205 may further receive UE-originated application requests, session requests, and event notifications in the form of a CCR.

Gx interface 210 may be an interface comprising hardware and/or executable instructions encoded on a machine-readable storage medium configured to communicate with a PGW such as PGW 134. Such communication may be implemented according to the 3GPP TS 29.212. Thus, Gx interface 210 may receive requests for PCC rules and transmit PCC rules for installation. Gx interface 210 may further receive UE-originated application requests, session requests, and event notifications in the form of a CCR.

Rx interface 215 may be an interface comprising hardware and/or executable instructions encoded on a machine-readable storage medium configured to communicate with AF 150. Such communication may be implemented according to the 3GPP TS 29.214. For example, Rx interface 215 may receive application requests, session requests, and event notifications in the form of an AAR.

Message handler 220 may include hardware and/or executable instructions on a machine-readable storage medium configured to process application and session requests received via Gxx interface 205, GX interface 210, and Rx interface 215. For example, message handler 220 may create and install new PCC rules in response to an application request. As a further example, message handler 220 may establish, modify, or terminate IP-CAN sessions and gateway control sessions in response to a session request. After fully processing a message, message handler 220 may construct and transmit a message over Gxx interface 205, GX interface 210, and/or Rx interface 215 to notify other nodes as to the result of processing the message. For example, if message handler 220 creates a new PCC rule in response to a request message, it may construct a reauthorization request (RAR) message to push the new PCC rule to an appropriate PGW.

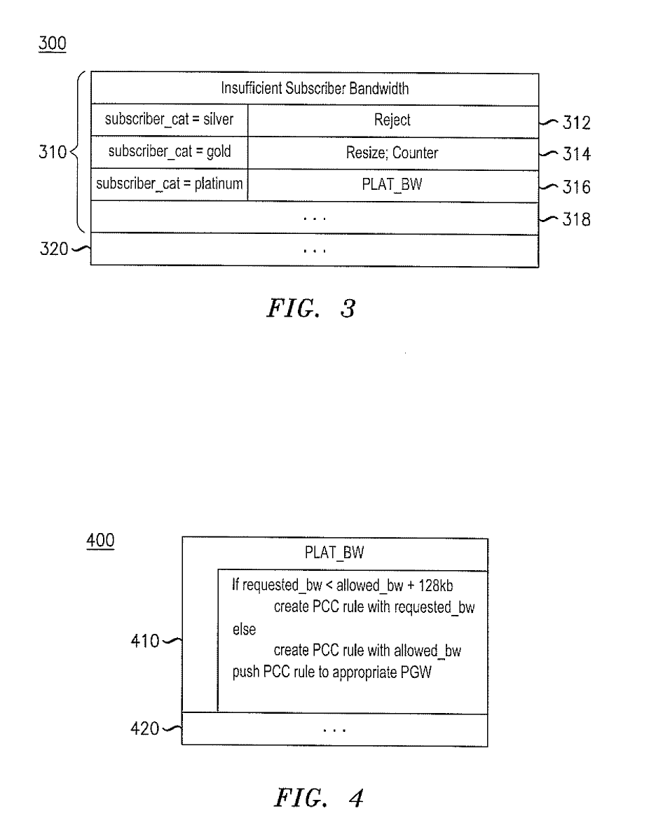

In processing various messages, message handler 220 may request a policy decision from policy decision engine 230 and base at least part of its response to the message on the policy decision results. Message handler 220 may provide context information from the message to policy decision engine 230, either directly or via context information module 225. Policy decision results may include an indication of an action that the message handler 220 should take in response to the message, in which case message handler may perform the specified action. Alternatively or additionally, policy decision results may include an indication of a predefined routine. In such a case, message handler 220 may retrieve the predefined routine from routine storage 240 and subsequently perform the routine. As will be described in further detail with reference to FIG. 4 below, such a predefined routine may include one or more steps or actions to be taken by the message handler 220.

Context information module 225 may include hardware and/or executable instructions on a machine-readable storage medium configured to provide various context information to policy decision engine 230. For example, context information module 225 may store information carried by a received message. Context information module 225 may further store previously received and/or transmitted messages associated with a subscriber, session, and/or service data flow. Context information module 225 may further access information stored elsewhere such as, for example, subscriber information stored in an SPR such as SPR 138.

Policy decision engine 230 may include hardware and/or executable instructions on a machine-readable storage medium configured to identify rules stored in rule storage 235 that are applicable to a received message or current context. As will be described in further detail below with respect to FIG. 3, each rule may include a criteria section which indicates when a rule is applicable. Policy decision engine 230 may compare this criteria section to context information passed by message handler 220 and/or retrieved from context information module 225. Upon locating an applicable rule, policy decision engine 230 may return the results portion of the rule to message handler 220.

Rule storage 235 may be any machine-readable medium capable of storing policy decision rules for use by policy decision engine 230. Accordingly, rule storage 235 may include a machine-readable storage medium such as read-only memory (ROM), random-access memory (RAM), magnetic disk storage media, optical storage media, flash-memory devices, and/or similar storage media. In various alternative embodiments, rule storage 235 may be a device that is external to PCRN 136. As will be described in further detail below with respect to FIG. 3, rule storage 235 may store definitions of numerous policy decision rules.

Routine storage 240 may be any machine-readable medium capable of storing predefined routines for use by message handler 220. Accordingly, routine storage 240 may include a machine-readable storage medium such as read-only memory (ROM), random-access memory (RAM), magnetic disk storage media, optical storage media, flash-memory devices, and/or similar storage media. Routine storage 240 may be an independent storage device or may be the same as rule storage 235. In various alternative embodiments, routine storage 240 may be a device that is external to PCRN 136. As will be described in further detail below with respect to FIG. 4, routine storage 245 may store definitions of numerous predefined routines. Such definitions may include, for example, a name, conditional statements, and/or indications of actions to be taken.

User interface 245 may include hardware and/or executable instructions on a machine-readable storage medium configured to provide a user with access to PCRN 136. User interface 245 may receive input from a user and may include hardware such as, for example, a keyboard and/or mouse. User interface 245 may also display information as output to the user and may include, for example, a monitor. A user may access rule manager 250 and/or routine manager 255 via user interface 245.

Rule manager 250 may include hardware and/or executable instructions on a machine-readable storage medium configured to define, modify, and otherwise manage policy decision rules. For example, rule manager 250 may receive a definition of a new policy decision rule via user interface 245, format the definition according to a standard policy decision rule syntax used by PCRN 136, and store the definition in rule storage 235. Rule manager 250 may further provide a definition of an existing policy decision rule to a user upon request via user interface 245. Rule manager 250 may subsequently receive a modified rule definition, format the definition if necessary, and store the definition in rule storage 235. In storing a modified definition, rule manager 250 may overwrite an existing definition or store the modified definition as a new version of the policy decision rule while preserving the old definition. Thus, rule manager 250 may provide version control functionality.

Routine manager 255 may include hardware and/or executable instructions on a machine-readable storage medium configured to define, modify, and otherwise manage routines. For example, routine manager 255 may receive a definition of a new routine via user interface 250, format the definition according to a standard routine syntax used by PCRN 136, and store the definition in routine storage 240. Routine manager 255 may further provide a definition of an existing routine to a user upon request via user interface 250. Routine manager 255 may subsequently receive a modified routine definition, format the definition if necessary, and store the definition in routine storage 240. In storing a modified definition, routine manager 255 may overwrite an existing definition or store the modified definition as a new version of the routine while preserving the old definition. Thus, routine manager 255 may provide version control functionality.

FIG. 3 illustrates an exemplary data arrangement 300 for storing policy decision rules. Data arrangement 300 may be, for example, a table in a database stored in rule storage 235 (FIG. 2), SPR 138 (FIG. 1), or another node (not shown) within EPC 130 (FIG. 1). Alternatively, data arrangement 300 could be a series of linked lists, an array, or a similar data structure. Thus, it should be apparent that data arrangement 300 is an abstraction of the underlying data; any data structure suitable for storage of the underlying data may be used.

Data arrangement 300 may include various rule sets for use in policy decisions related to various types of messages and in other contexts. Rule sets may be defined based on various context aspects. For example, each rule set may be defined to apply to certain received messages such as an IP-CAN modification request or service data flow request. Additionally or alternatively, rules sets may be defined to apply to particular conflicts or events that may prompt the request for a policy decision function such as, for example, the loss of a bearer, a request for more resources than are available, or a request for more resources than are allowed for a particular subscriber.

In the example of data arrangement 300, rule set 310 may include rules applicable when a subscriber has requested more bandwidth than the subscriber is allowed. It should be noted that rule set 310 is a simplification in some respects. For example, rule set 310 may be applicable to requests for one or more of the following: aggregate maximum bandwidth, maximum bandwidth, and guaranteed bandwidth. Data arrangement 300 may include additional rule sets 320.

Rule set 310 may include a number of rules 312, 314, 316, 318. Each rule may include a criteria section for use in determining whether the rule is applicable and a result section for indicating an action to be taken if the rule is applicable. As an example, rule 312 indicates that it is applicable when the subscriber category is ‘silver.’ It should be noted that the exemplary criteria section is in some respects a simplification and that various implementations may use additional and/or alternative conditions for application of a rule. Rule 312 further indicates that, when applicable, the PCRN 136 should reject the message being processed.

A result section may indicate more than one action to be taken by a PCRN such as PCRN 136. As an example, rule 314 may indicate that it is applicable when the subscriber category is ‘gold.’ When applicable, rule 314 indicates that the request should be first resized such that it would not create a conflict. Rule 314 further indicates that the resized request should be returned to the requesting node as a counteroffer. Thereafter, the requesting node may submit an additional request in accordance with the counter offer which the PCRN 136 may process as a new request.

In various embodiments, a rule may indicate a predefined routine that the PCRN 136 should follow in responding to the message. Thus, rule 316 indicates that it is applicable when the subscriber category is ‘platinum,’ and that the PCRN should perform a routine having the name PLAT_BW in responding to the current message. As will be described in further detail with respect to FIG. 4 below, PLAT_BW may include indications of actions to be taken and/or instructions to be executed by the PCRN 136. Rule set 310 may include additional rules 318.

FIG. 4 illustrates an exemplary data arrangement 400 for storing predefined routines. Data arrangement 400 may be, for example, a table in a database stored in routine storage 240 (FIG. 2), SPR 138 (FIG. 1), or another node (not shown) within EPC 130 (FIG. 1). Alternatively, data arrangement 400 could be a series of linked lists, an array, or a similar data structure. Thus, it should be apparent that data arrangement 400 is an abstraction of the underlying data; any data structure suitable for storage of the underlying data may be used.

Data arrangement 400 may include a routine 410 and additional routines 420. In various embodiments, routines 410, 420 may be organized within routine sets (not shown) similar to the rule sets 310, 320 used in data arrangement 300 (FIG. 3). In such embodiments, rules within a particular rule set can reference those routines within the corresponding routine set. In other embodiments, data arrangement 400 may not include routine sets, and any rule may be able to reference any routine, regardless of the rule set to which the rule belongs.

Routine 410 may be identified as “PLAT_BW,” and may contain instructions for execution by the PCRN 136. It should be noted that the particular routine 410 is defined in terms of pseudocode. In various implementations, routine 410 may contain compiled instructions, interpreted instructions, and/or enumerated actions to be taken similar to those used in exemplary rules 312, 314. Thus, predefined routines such as routines 410, 420 may be of any complexity, including single step routines. Routine 410 may indicate that PCRN 136 should compare the requested bandwidth to the bandwidth allowed for the relevant subscriber. Such allowed bandwidth may be retrieved from, for example, a record stored in an SPR such as SPR 138. If the requested bandwidth does not exceed the allowed bandwidth by more than 128 kb, then the PCRN 136 should simply create a PCC rule according to the request. If, on the other hand, the requested bandwidth exceeds the allowed bandwidth by more than 128 kb, then the PCRN 136 should create a PCC rule according to the request with the exception that the allowed bandwidth should be used instead of the requested bandwidth. Finally, the PCRN 136 should push the new PCC rule to the relevant PGW for installation.

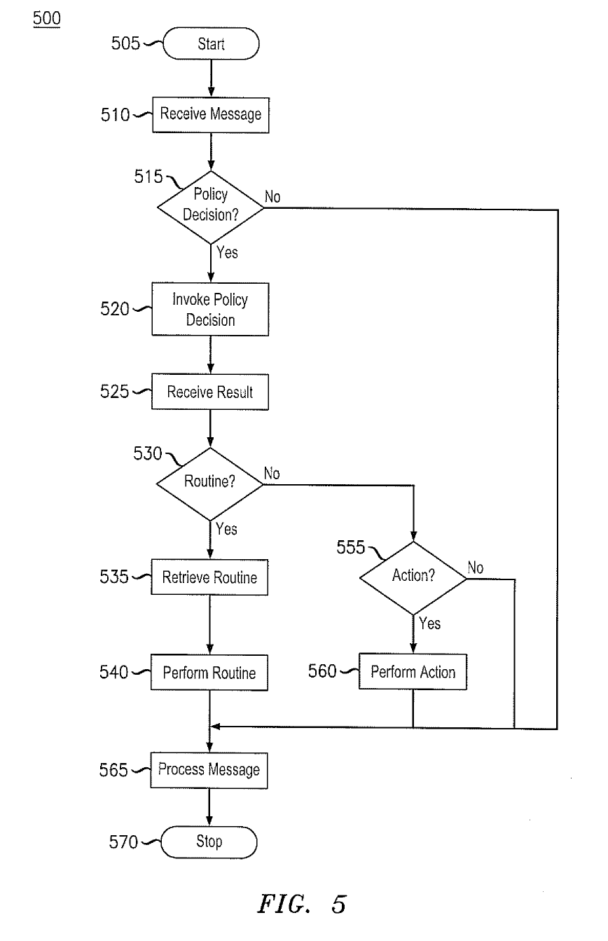

FIG. 5 illustrates an exemplary method 500 for processing a received message in accordance with an action indicated by a policy decision result. Method 500 may be performed by the components of PCRN 136 and/or PCRN 136 such as, for example, message handler 220.

Method 500 may begin in step 505 and proceed to 510 where PCRN 136 may receive a message via Gxx interface 205, Gx interface 210, and/or Rx interface 215. Method 500 may then proceed to step 515, where PCRN 136 may determine whether a policy decision should be made in order to process the received message. For example, PCRN 136 may determine that a requested parameter conflicts with a subscriber record or the currently available resources. Alternatively, PCRN 136 may determine that the message is of a type or contains an indication of an event for which a policy decision is necessary. If such a policy decision is necessary, method 500 may proceed to step 520; otherwise method 500 may proceed to step 565.

PCRN 136 may invoke a policy decision in step 520 and then receive a policy decision result in step 525. Method 500 may then proceed to step 530 where PCRN 136 may determine whether the received result includes an indication of a predefined routine. If so, PCRN 136 may retrieve the specified routine in step 535 and perform the steps specified by the routine in step 540.

If, on the other hand, the result does not contain a routine reference, method 500 may proceed from step 530 to step 555, where PCRN 136 may determine whether the result indicates an action to be taken. If the result does indicate an action, PCRN 136 may perform the action in step 560 and proceed to step 565. If the result does not indicate an action, PCRN 136 may take other appropriate steps (not shown) and proceed directly to step 565.

At step 565, PCRN 136 may finish processing the message. For example, PCRN 136 may complete a response message and send it to the requesting node, if this has not been done already. Alternatively, if all processing has already been completed through the processing of a rule, PCRN 136 may do nothing at step 565. Method 500 may then end in step 570.

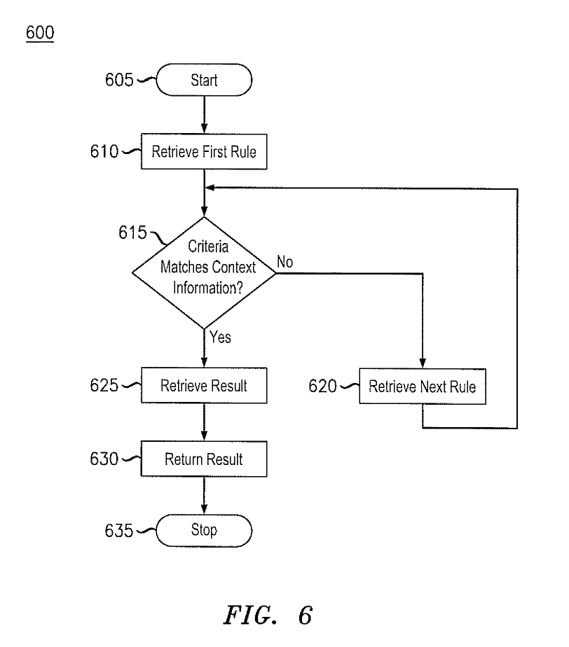

FIG. 6 illustrates and exemplary method 600 for performing a policy decision. Method 600 may be performed by the components of PCRN 136 and/or PCRN 136 such as, for example, policy decision engine 230. Method 600 may correspond to step 520 (FIG. 5) or may be performed in parallel to method 500 after the execution of step 520.

Method 600 may begin in step 605 and proceed to step 610 where PCRN 136 may retrieve a first rule from the applicable rule set. PCRN 136 may determine the applicable rule set from context information stored in context information module 225 or message handler 220 may specify a rule set when invoking a policy decision. After retrieving a first rule, method 600 may proceed to step 615.

At step 615, PCRN 136 may compare the criteria portion of the rule to relevant context information passed by message handler 220 and/or context information module 225. If the criteria does not match the context information, method 600 may proceed to step 620 where PCRN 136 may retrieve the next rule from rule storage 230. Method 600 may then loop back to step 615.

If, on the other hand, PCRN 136 determines that the criteria section of a rule matches the context information at step 615, method 600 may proceed to step 625. At step 625, PCRN 136 may retrieve the result from the result section of the matching rule. Method 600 may then proceed to step 630 where PCRN 136 may return the rule result for further processing. Method 600 may then end in step 635.

Having described exemplary components and methods for the operation of exemplary subscriber network 100 and PCRN 136, an example of the operation of exemplary network 100 and PCRN 136 will now be provided with reference to FIGS. 1-6. PCRN 136 may correspond to PCRN 136. The contents of rule storage 235 may be indicated by data arrangement 300 and the contents of routine storage 240 may be indicated by data arrangement 400.

The process may begin when PCRN 136 receives CCR 170 requesting the establishment of a new service data flow with 512 kbps bandwidth. Message handler 220 then attempts to create a PCC rule establishing the data flow but determines in step 515 that the subscriber is only allowed to have 256 kbps bandwidth. Message handler 220 then requests a policy decision from policy decision engine 230 in step 520, indicating that rule set 310 should be used.

Policy decision engine 230 retrieves rule 312 in step 610. Since the criteria section uses the subscriber_cat variable, policy decision engine 230 may request this information from context information module 225. Context information module, in turn, may retrieve the record associated with the subscriber ID from SPR 138 and determine that subscriber_cat is “gold.” Policy decision engine 230 then determines that rule 312 is not applicable at step 615 because “gold” does not match “silver.” Policy decision engine 230 then retrieves rule 314 at step 620. Since the criteria of rule 314 specifies that the rule is applicable when subscriber_cat is “gold,” policy decision engine 230 determines that rule 314 is applicable in step 615, extracts the result ‘Resize; Counter’ from rule 314 in step 625, and returns the result in step 630.

Message handler 220 receives the result in step 525 and determines that the result is not a routine identifier in step 530. Then, in step 555, message handler 220 determines that the result indicates an action to be taken. Message handler 220 then resizes the request according to the allowed bandwidth for the subscriber and sends it as a counteroffer to PGW 134 in step 560, as specified by rule 314. PCRN 136 may determine that no further action should be taken at this time in step 565, since the counteroffer has already been sent.

According to the foregoing, various exemplary embodiments provide for the externalization of PCRN behavior. Particularly, by providing behavioral rules for determining what action a PCRN should take in response to a received message, a manufacturer or a user may define how a PCRN responds to a message under various circumstances. Thus, the behavior of a PCRN may be fine-tuned to handle differing situations in appropriate manners and may be updated to evolve with the network.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method for determining the behavior of a policy and charging rules node (PCRN), the method comprising:
receiving a message at a PCRN;
determining whether a policy decision should be made with regard to the received message;
when a policy decision should be made:
identifying a rule of a plurality of rules as applicable to processing the received message, wherein the identified rule specifies an action to be taken in response to the received message,
performing the action in response to the received message; and
when a policy decision should not be made, processing the received message according to normal procedures.

2. The method of claim 1, wherein the action to be taken in response to the received message comprises one or more of the following: rejecting a request, accepting a request, and modifying a request.

3. The method of claim 1, wherein the action to be taken in response to the received message includes a predefined routine.

4. The method of claim 1, wherein the message includes a request and the determining that comprises identifying a conflict between the request and at least one of: a subscriber record and a measure of resource availability.

5. The method of claim 1, wherein the determining comprises determining that the received message includes a notification of a change in network status.

6. The method of claim 5, wherein the notification of a change in network status is a notification of a loss of a bearer.

7. The method of claim 1, further comprising:
receiving a definition of a user-defined rule from a user, wherein the user-defined rule is one of a new rule and a modified version of an existing rule; and
storing the definition of the user-defined rule with the plurality of rules,
wherein the user-defined rule is identified as applicable to processing the message.

8. A policy and charging rules node (PCRN) comprising:
an interface that receives a message from another node;
a rule storage that stores a plurality of rules, wherein at least one rule includes an indication of an action to be taken in response to the received message;
a message handler configured to:
determine that a policy decision should be made with regard to the message, and
request a policy decision; and
a policy decision engine that:
determine that the at least one rule of the plurality of rules is applicable to a current context, and
return the indication of the action to the message handler, wherein the message handler subsequently performs the action.

9. The PCRN of claim 8, wherein the indication of the action comprises an indication of one or more of the following: rejecting a request, accepting a request, and modifying a request.

10. The PCRN of claim 8, wherein the indication of the action includes an indication of a predefined routine.

11. The PCRN of claim 8, wherein the received message includes a request and, in determining that a policy decision should be made with regard to the received message, the message handler identifies a conflict between the request and at least one of: a subscriber record and a measure of resource availability.

12. The PCRN of claim 8, wherein, in determining that a policy decision should be made with regard to the message, the message handler determines that the message includes a notification of a change in network status.

13. The PCRN of claim 8, further comprising:
a user interface that receives a definition of a user-defined rule, wherein the user-defined rule is one of a new rule and a modified version of an existing rule of the plurality of rules; and
a rule manager that stores the definition of the user-defined rule,
wherein the user-defined rule is the at least one rule that is identified as applicable to the current context.

14. A machine-readable storage medium encoded with instructions for execution on a policy and charging rules node (PCRN), the machine-readable storage medium comprising:
instructions for receiving a message at a PCRN;
instructions for determining whether a policy decision should be made with regard to the received message;
instructions for, when a policy decision should be made:
identifying a rule of a plurality of rules as applicable to processing the received message, wherein the identified rule specifies an action to be taken in response to the received message,
performing the action in response to the received message; and
instructions for, when a policy decision should not be made, processing the received message according to normal procedures.

15. The machine-readable storage medium of claim 14, wherein the action to be taken in response to the received message comprises one or more of the following:
rejecting a request, accepting a request, and modifying a request.

16. The machine-readable storage medium of claim 14, wherein the action to be taken in response to the received message includes a predefined routine.

17. The machine-readable storage medium of claim 14, wherein the message includes a request and the instructions for determining that a policy decision should be made comprise identifying a conflict between the request and at least one of: a subscriber record and a measure of resource availability.

18. The machine-readable storage medium of claim 14, wherein the instructions for determining comprise determining that the received message includes a notification of a change in network status.

19. The machine-readable storage medium of claim 18, wherein the notification of a change in network status is a notification of a loss of a bearer.

20. The machine-readable storage medium of claim 14, further comprising:
instructions for receiving a definition of a user-defined rule from a user, wherein the user-defined rule is one of a new rule and a modified version of an existing rule; and
instructions for storing the definition of the user-defined rule with the plurality of rules,
wherein the user-defined rule is identified as applicable to processing the message.
